(19) United States
(12) Patent Application Publication
(10) Pub. No.: US 2022/0308532 A1
(43) Pub. Date: Sep. 29, 2022

(54) STATE ESTIMATION SYSTEM AND STORAGE MEDIUM

(71) Applicant: HONDA MOTOR CO., LTD., Tokyo (JP)

(72) Inventors: Shigeru Namiki, Wako-shi (JP); Minoru Uoshima, Wako-shi (JP)

(21) Appl. No.: 17/679,147

(22) Filed: Feb. 24, 2022

(30) Foreign Application Priority Data
Mar. 25, 2021 (JP) 2021-051462

(51) Int. Cl. G05B 13/02

(52) U.S. Cl. CPC G05B 13/0265; G07C 5/008

(57) ABSTRACT

A state estimation system includes: a learned model generated through machine learning in which sample data of first and second state variables of a predetermined target is training data; a first state variable measurement unit configured to measure the first state variable of a monitoring target; a second state variable estimation unit configured to perform a second state variable estimation process of inputting a measured value of the first state variable into the learned model and acquiring an output of the learned model as an estimated value of the second state variable of the monitoring target; and an alternative estimation unit configured to output an alternative estimated value which is an alternative value of the estimated value of the second state variable in a case in which a predetermined first sudden change determination condition is satisfied by the estimated value of the second state variable acquired in response to an input of a first measured value of the first state variable through the second state variable estimation process.

### CROSS-REFERENCE TO RELATED APPLICATION

Priority is claimed on Japanese Patent Application No. 2021-051462, filed Mar. 25, 2021, the content of which is incorporated herein by reference.

### BACKGROUND OF THE INVENTION

### Field of the Invention

The present invention relates to a state estimation system and a storage medium.

### Description of Related Art

Secondary cell lifespan estimation systems estimating lifespans of secondary cells using neural networks have been proposed (for example, see Japanese Unexamined Patent Application, First Publication No. 2014-206499). Such secondary cell lifespan estimation systems generate characteristics databases in which measured values of characteristics of evaluation secondary cells and result values of dischargeable times are associated by repeatedly charging and discharging the evaluation secondary cells. The secondary cell lifespan estimation systems generate learned models that input measured values of predetermined characteristics using the characteristics databases as training data and output estimated values of the dischargeable times.

### SUMMARY OF THE INVENTION

In the foregoing learned models, accuracy of estimated values output with regard to states of targets such as secondary cells deteriorates in some cases. Compensation is required to be performed to treat with the case of the deterioration in the accuracy of the estimated values.

Aspects of the present invention have been considered in view of the foregoing circumstances and an objective of the present invention is to provide a state estimation system and a storage medium capable of compensating for deterioration in accuracy of estimated values output by a learned model.

To solve the foregoing problem and achieve the objective, the following aspects are adopted in the present invention.

(1) According to an aspect of the present invention, a state estimation system includes: a learned model generated so that a measured value of a first state variable is input and an estimated value of a second state variable is output through machine learning in which sample data of the first and second state variables of a predetermined target is training data; a first state variable measurement unit configured to measure the first state variable of a monitoring target which is the target serving as a monitoring target; a second state variable estimation unit configured to repeatedly perform, at a predetermined estimation timing, a second state variable estimation process of inputting the measured value of the first state variable measured by the first state variable measurement unit into the learned model and acquiring an output of the learned model as the estimated value of the second state variable of the monitoring target; and an alternative estimation unit configured to output an alternative estimated value which is an alternative value of the estimated value of the second state variable in a case in which a predetermined first sudden change determination condition is satisfied by the estimated value of the second state variable acquired in response to an input of a first measured value of the first state variable through the second state variable estimation process.

(2) In the state estimation system according to the aspect of (1), the alternative estimation unit may output the alternative estimated value in accordance with another method which is a substitute for the learned model used in the second state variable estimation process to correspond to the case in which a first sudden change determination condition is satisfied.

(3) In the state estimation system according to the aspect of (2), he learned model in the second state variable estimation unit may be updated. The alternative estimation unit may output the alternative estimated value using a learned model before the updating to the used learned model.

(4) In the state estimation system according to the aspect of any one of (1) to (3), the first sudden change determination condition may be a condition that a first estimated value of the second state variable acquired through the second state variable estimation process from the input of the first measured value of the first state variable is changed by a given value or more with respect to a second estimated value of the second state variable acquired through the second state variable estimation process from an input of a second measured value of the first state variable measured by the first state variable measurement unit at an estimation timing earlier than an estimation timing at which the first measured value is input.

(5) In the state estimation system according to the aspect of any one of (1) to (4), the monitoring target may be mounted in a moving object. The state estimation system may further include an estimation accuracy deterioration treating unit configured to perform a predetermined process performed on the basis of the estimated value in the moving object on the basis of the alternative estimated value instead of the estimated value in accordance with calculation of the alternative estimated value by the alternative estimation unit.

(6) In the state estimation system according to the aspect of (5), the predetermined process may be display of a state of the monitoring target on a display unit equipped in the moving object.

(7) In the state estimation system according to the aspect of (5), the predetermined process may be control of an electrically driven motor equipped in the moving object.

(8) In the state estimation system according to the aspect of (5), the estimation accuracy deterioration treating unit may prohibit the predetermined process based on the alternative estimated value from being performed in a case in which a predetermined second sudden change determination condition is satisfied by the alternative estimated value when the alternative estimated value is calculated by the alternative estimation unit.

(9) In the state estimation system according to the aspect of (8), the predetermined process may be display of a state of the monitoring target on a display unit equipped in the moving object. The estimation accuracy deterioration treating unit may cause the display unit to display the state of the monitoring object on the basis of a second estimated value of the second state variable acquired through the second state variable estimation process at an estimation timing earlier than an estimation timing at which the first measured value is input when the state of the monitoring target is prohibited from being displayed on the display unit based on the alternative estimated value.

(10) In the state estimation system according to the aspect of (8), the predetermined process may be control of an electrically driven motor equipped in the moving object. The estimation accuracy deterioration treating unit may control the electrically driven motor on the basis of a preset upper limit or lower limit of a predetermined range of the second state variable when the electrically driven motor is prohibited from being controlled.

(11) In the state estimation system according to the aspect of any one of (1) to (10), the monitoring target may be a battery. The first state variable may include at least one of a voltage, a current, and a temperature of the battery. The second state variable may be a state of charge (SOC) of the battery.

(12) According to another aspect of the present invention, a computer-readable non-transitory storage medium stores a program causing a computer to function as: a learned model generated so that a measured value of a first state variable is input and an estimated value of a second state variable is output through machine learning in which sample data of the first and second state variables of a predetermined target is training data; a first state variable measurement unit configured to measure the first state variable of a monitoring target which is the target serving as a monitoring target; a second state variable estimation unit configured to repeatedly perform, at a predetermined estimation timing, a second state variable estimation process of inputting the measured value of the first state variable measured by the first state variable measurement unit into the learned model and acquiring an output of the learned model as the estimated value of the second state variable of the monitoring target; and an alternative estimation unit configured to output an alternative estimated value which is an alternative value of the estimated value of the second state variable in a case in which a predetermined first sudden change determination condition is satisfied by the estimated value of the second state variable acquired in response to an input of a first measured value of the first state variable through the second state variable estimation process.

According to (1) and (12), an alternative estimated value which is a substitute for the estimated value of the output second state variable is output when the first sudden change determination condition is satisfied by the estimated value of the second state variable output by the learned model into which the measured value obtained by measuring the target is input. Thus, it is possible to compensate for the deterioration in the accuracy of the estimated value of the second state variable output by the learned model by using the alternative estimated value.

According to (2), when the alternative estimated value is calculated, the other method different from the learned model outputting the estimated value of the second state variable at the time of satisfaction of the first sudden change determination condition is used. Thus, the alternative estimated value can be obtained without using the learned model outputting the estimated value of the second state variable at the time of satisfaction of the first sudden change determination condition. Therefore, it is possible to appropriately compensate for deterioration of the estimated value of the second state variable output by the learned model.

According to (3), the alternative estimated value can be calculated and the alternative estimated value can be obtained using the learned model before the updating to the learned model without using the learned model outputting the estimated value of the second state variable at the time of satisfaction of the first sudden change determination condition. Thus, it is possible to appropriately compensate for a decrease in deterioration in the accuracy of the estimated value of the second state variable.

According to (4), on the basis of the degree of deviation between the estimated value (the first estimated value) of the presently output second state variable and the estimated value (the second estimated value) of the second state variable output earlier than the present time, it is possible to appropriately determine whether the first sudden change determination condition is satisfied.

According to (5), when the estimated value of the second state variable is considered to be suddenly changed and the alternative estimated value is calculated, an operation performed through the predetermined process can be set to be within a normal range by performing the process on the basis of the alternative estimated value with regard to the predetermined process performed on the basis of the estimated value of the second state variable.

According to (6), when the estimated value of the second state variable is considered to be suddenly changed and the accuracy of the estimated value of the second state variable is in a low state, an operation of displaying the state of the monitoring target equipped in the moving object can also be set to be within a normal range.

According to (7), when the estimated value of the second state variable is considered to be suddenly changed and the accuracy of the estimated value of the second state variable is in a low state, an operation of controlling the electrically driven motor equipped in the moving object can also be set to be within a normal range.

According to (8), when the accuracy of the alternative estimated value is considered to be in a low state, it is possible to prevent an operation performed through the predetermined process from being outside of a normal range by prohibiting the predetermined process performed on the basis of the estimated value of the second state variable.

According to (9), it is possible to prohibit display of the state of a monitoring target performed on the basis of the estimated value of the second state variable and it is possible to perform display of the state of the monitoring target on the basis of the estimated value of the second state variable before satisfaction of the first sudden change determination condition. Thus, even in a state in which the accuracy of even the alternative estimated value is considered to be low, it is possible to prevent an operation of displaying the state of the monitoring target from being outside of a normal range.

According to (10), it is possible to prohibit control of the electrically driven motor performed on the basis of the estimated value of the second state variable and it is possible to perform control of the electrically driven motor on the basis of the estimated value of the second state variable before satisfaction of the first sudden change determination condition. Thus, even in a state in which the accuracy of even the alternative estimated value is considered to be low, it is possible to prevent an operation of controlling the electrically driven motor from being outside of a normal range.

According to (11), it is possible to appropriately compensate for a state in which the accuracy of the estimated value of the SOC of the battery is lowered.

### BRIEF DESCRIPTION OF THE DRAWINGS

FIG. 1 is a diagram illustrating an exemplary configuration of a state estimation system according to an embodiment.

FIG. 2 is a flowchart illustrating an exemplary order of a process performed with regard to an output of an SOC estimated value by a vehicle controller according to a first embodiment.

FIG. 3 is a flowchart illustrating an exemplary order of a process performed with regard to an output of an SOC estimated value by a vehicle controller according to a second embodiment.

FIG. 4 is a flowchart illustrating an exemplary order of a process performed with regard to updating of a learned model as a regular model by a management server and the vehicle controller according to the second embodiment.

### DETAILED DESCRIPTION OF THE INVENTION

Hereinafter, embodiments of a state estimation system and a storage medium according to the present invention will be described with reference to the drawings.

### First Embodiment

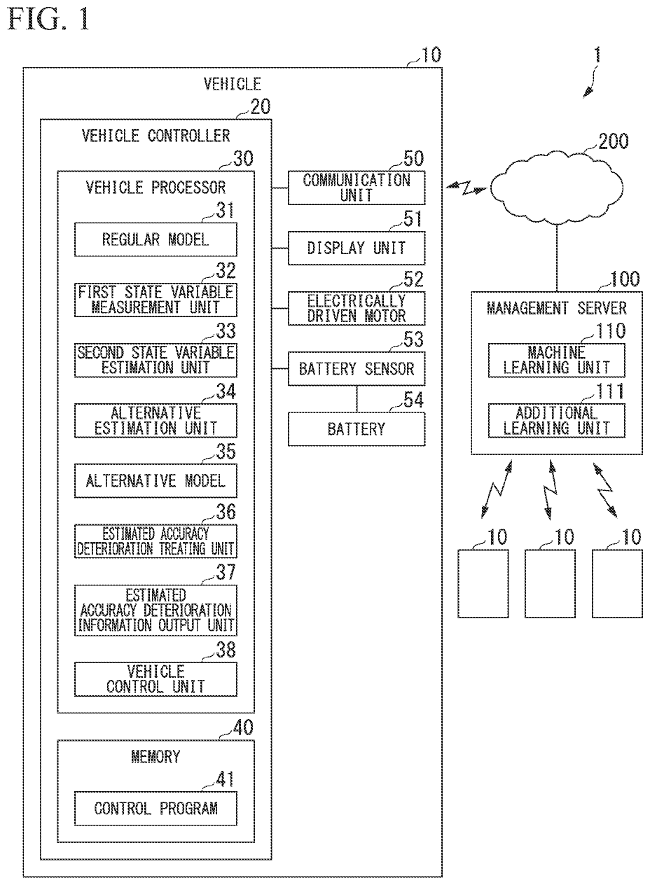

FIG. 1 illustrates an exemplary overall configuration of a state estimation system 1 according to the embodiment. The state estimation system 1 in the drawing includes a plurality of vehicles 10 (which are examples of moving objects) and a management server 100. The vehicle 10 and the management server 100 are connected to be able to communicate with each other via a network 200.

In the drawing, the plurality of vehicles 10 are illustrated, but the number of vehicles 10 included in the state estimation system 1 is not particularly limited as long as the number of vehicles 10 is one or more.

The vehicles 10 in the drawings are, for example, the same types of vehicles and individually have similar configurations. The vehicle 10 is an electric vehicle that includes a battery 54 (which is an example of a monitoring target) and an electrically driven motor 52 and operates the electrically driven motor 52 with power supplied from the battery 54 so that the electric vehicle (an electric automobile, a hybrid automobile, or the like) travels.

The vehicle 10 includes a vehicle controller 20, a communication unit 50, a display unit 51, and a battery sensor 53.

The communication unit 50 includes a communication processor such as a modem modulator demodulator (modem). The communication unit 50 performs communication with the management server 100 via the network 200.

The display unit 51 performs display under the control of the vehicle controller 20.

The battery sensor 53 detects a voltage, a current, a temperature, and the like of the battery 54 and outputs detected signals to the vehicle controller 20.

The vehicle controller 20 performs communication with the communication unit 50, the display unit 51, the electrically driven motor 52, and the battery sensor 53 in accordance with a controller area network (CAN) protocol.

The vehicle controller 20 includes a vehicle processor 30 and a memory 40.

The vehicle processor 30 (which is an example of a computer) is configured by one processor or a plurality of processors. The vehicle processor 30 implements a function of each functional unit in the vehicle processor 30 by reading and executing a control program 41 of the vehicle 10 stored in the memory 40.

The control program 41 may be transmitted from the management server 100 to the vehicle 10 and may be stored in the memory 40 under the control of the vehicle controller 20. Alternatively, the control program 41 stored in a storage medium (not illustrated) may be read by the vehicle controller 20 and may be stored in the memory 40.

The vehicle processor 30 includes, as functional units, a regular model 31, a first state variable measurement unit 32, a second state variable estimation unit 33, an alternative estimation unit 34, an alternative model 35, an estimated accuracy deterioration treating unit 36, an estimated accuracy deterioration information output unit 37, and a vehicle control unit 38.

The regular model 31 is a learned model generated by a machine learning unit 110 equipped in the management server 100. The regular model 31 inputs each value (which is an example of a first state variable) of a voltage (an inter-terminal voltage), a current (an input/output current), and a temperature of the battery 54 detected by the battery sensor 53 and outputs an estimated value (which is an example of a second state variable) of a states of charge (SOC) of the battery 54.

The first state variable may be not all of the voltage, the current, and the temperature of a battery but at least any one thereof. As the first state variable, a detected value of another battery 54 may be used in addition to at least one of the voltage, the current, and the temperature. A detected value of the battery 54 may be considered as the first state variable other than the voltage, the current, and the temperature. The second state variable may be a variable other than the SOC.

The machine learning unit 110 uses a sample data set indicating a relation between the first state variable and the second state variable of the battery obtained by an evaluation experiment or the like of an evaluation battery as training data. The machine learning unit 110 performs machine learning of a machine learning model (an identifier internally kept in a relation between input data and output data) using the training data to generate the regular model 31. As the machine learning model, a model of a neural network, a support vector machine, or the like is used. For example, the machine learning model may be configured using a recurrent neural network (RNN) and an intermediate layer of the RNN may be configured by a long short-term memory (LSTM) or a gated recurrent unit (GRU).

The first state variable measurement unit 32 obtains measured values (which are examples of measured values of the first state variables) of a voltage, a current, and a temperature of the battery 54 on the basis of a voltage, a current, and a temperature output from the battery sensor 53.

The second state variable estimation unit 33 performs a process of inputting the measured values of the voltage, the current, and the temperature of the battery 54 obtained by the first state variable measurement unit 32 into the regular model 31 and acquiring outputs of the regular model 31 as the estimated values of the SOC (which are examples of a regular SOC estimated value and an estimated value of the second state variable) of the battery 54 (a second state variable estimation process).

The second state variable estimation unit 33 may input a voltage, a current, and a temperature output from the battery sensor 53 as first measured values. In this case, the first state variable measurement unit 32 may be omitted.

When a predetermined first sudden change determination condition is satisfied by a regular SOC estimated value acquired through a second state variable estimation process performed by the second state variable estimation unit 33, the alternative estimation unit 34 outputs an alternative SOC estimated value (which is an example of an alternative estimated value) which is an alternative value of the regular SOC estimated value. That is, when the first sudden change determination condition is satisfied, the vehicle processor 30 acquires the alternative SOC estimated value instead of the regular SOC estimated value as the SOC estimated value of the battery 54.

The alternative estimation unit 34 outputs the SOC estimated value calculated by the alternative model 35 as the alternative SOC estimated value.

The alternative model 35 according to the embodiment may calculate the alternative SOC estimated value, for example, on the basis of an integrated value of a current measured by the first state variable measurement unit 32.

The alternative SOC estimated value calculated by the alternative model 35 can be treated as a value with accuracy higher than the regular SOC estimated value satisfying the first sudden change determination condition.

The alternative estimation unit 34 determines whether the first sudden change determination condition is satisfied as follows.

The alternative estimation unit 34 acquires a first regular SOC estimated value Sv1(t1) which is an estimated value of the SOC estimated from an input of a measured value (a first measured value Mv(t1)) of a voltage, a current, or a temperature of the battery 54 input by the second state variable estimation unit 33 in present estimation of the SOC.

The alternative estimation unit 34 acquires a second regular SOC estimated value Sv2(t2) which is an estimated value of the SOC estimated from the input of a measured value (a second measured value Mv(t2)) of a voltage, a current, or a temperature of the battery 54 input by the second state variable estimation unit 33 through the previous estimation of the (immediately previous) SOC.

When it is determined whether the first sudden change determination condition is satisfied, the alternative estimation unit 34 determines whether the first regular SOC estimated value Sv1(t1) is changed by a given value or more with respect to the second regular SOC estimated value Sv2(t2).

Specifically, the alternative estimation unit 34 may calculate a difference (a difference estimated value) between the first regular SOC estimated value and the second regular SOC estimated value. The difference estimated value may be an absolute value of the difference between the first regular SOC estimated value and the second regular SOC estimated value. When the difference estimated value is equal to or greater than a predetermined value, the alternative estimation unit 34 may determine that the first sudden change determination condition is satisfied.

Alternatively, when a rate of change of the first regular SOC estimated value to the second regular SOC estimated value is equal to or greater than a given value, the alternative estimation unit 34 may determine that the first sudden change determination condition is satisfied.

Even when the first measured value (Mv(t1)) measured by the first state variable measurement unit 32 deviates from an input assumption range set in accordance with the range of the first state variable in training data in the present estimation of the SOC, the alternative estimation unit 34 may determine that the first sudden change determination condition is satisfied. The input assumption range may be set to, for example, a range slightly narrower than the range of the first state variable in the training data.

The vehicle control unit 38 in the vehicle 10 performs display of a state of the battery 54 (battery state display) and control of the electrically driven motor 52 (electrically driven motor control) as a process (a process of using SOC estimated value) performed on the basis of the SOC estimated value (using the SOC estimated value).

The vehicle control unit 38 causes the display unit 51 to display a charging rate or a travelable distance of the battery 54 on the basis of the SOC estimated value input as the battery state display.

The vehicle control unit 38 adjusts a charging amount (a regeneration amount) to the battery 54 by the electrically driven motor 52 or power of the battery 54 (a charging amount of the battery 54) input by the electrically driven motor 52 on the basis of the SOC estimated value input as the electrically driven control based on the SOC estimated value.

There is a possibility of accuracy of the regular SOC estimated value being considerably low when the first sudden change determination condition is satisfied. In this case, there is a high possibility of accuracy of the alternative SOC estimated value being higher than that of the regular SOC estimated value. Accordingly, when the first sudden change determination condition is satisfied, the estimated accuracy deterioration treating unit 36 performs the foregoing process of using SOC estimated value on the basis of the alternative SOC estimated value instead of the regular SOC estimated value.

Thus, a charging rate, a travelable distance, or the like shown in the battery state display is inhibited from being changed steeply. The electrically driven motor 52 is controlled within a range in which maintenance is achieved without overcharge or over discharge. That is, when the first sudden change determination condition is satisfied, a normal range of a result of the process of using SOC estimated value can be maintained on the basis of the alternative SOC estimated value.

Further, due to a certain factor, the alternative SOC estimated value calculated by the alternative estimation unit 34 is also a value exceeding an assumed range, and thus accuracy is considerably lowered. It is not desirable that the alternative SOC estimated value exceeding the assumed range is also used in the process of using SOC estimated value in terms of reliability or the like.

Accordingly, the estimated accuracy deterioration treating unit 36 determines whether a second sudden change determination condition is satisfied by the alternative SOC estimated value calculated by the alternative estimation unit 34.

The estimated accuracy deterioration treating unit 36 may determine whether the second sudden change determination condition is satisfied depending on whether the regular SOC estimated value acquired by the second state variable estimation unit 33 in a stage before (for example, immediately before) the satisfaction of the first sudden change determination condition is changed by a given value with respect to the SOC estimated value calculated by the alternative estimation unit 34.

As a specific example, the estimated accuracy deterioration treating unit 36 may determine that the second sudden change determination condition is satisfied when a difference between the alternative SOC estimated value calculated by the alternative estimation unit 34 and the regular SOC estimated value acquired by the second state variable estimation unit 33 in the stage before (for example, immediately before) the satisfaction of the first sudden change determination condition is equal to or greater than a given value.

Alternatively, the estimated accuracy deterioration treating unit 36 may determine that the second sudden change determination condition is satisfied when a rate of change of the alternative SOC estimated value which is an estimated value of the regular SOC estimated value acquired by the second state variable estimation unit 33, for example, in the stage before (for example, immediately before) the satisfaction of the first sudden change determination condition is equal to or greater than the given value.

The estimated accuracy deterioration treating unit 36 prohibits the process of using the SOC estimated value based on the alternative SOC estimated value when the second sudden change determination condition is determined. Further, the estimated accuracy deterioration treating unit 36 performs the process of using the SOC estimated value on the basis of a provisional SOC estimated value which is provisionally determined.

The estimated accuracy deterioration treating unit 36 may merely prohibit the process of using the SOC estimated value based on the alternative SOC estimated value when the second sudden change determination condition is determined. In the following description, however, a case in which the process of using the SOC estimated value based on the alternative SOC estimated value is prohibited and the process of using the SOC estimated value based on the provisional SOC estimated value which is provisionally determined is performed when the second sudden change determination condition is determined will be exemplified.

The estimated accuracy deterioration treating unit 36 may use a different provisional SOC estimated value through the battery state display and the electrically driven motor control. Specifically, in the battery state display, the estimated accuracy deterioration treating unit 36 may perform display based on the above-described second measured value Mv(t2) as the provisional SOC estimated value. In the electrically driven motor control, the estimated accuracy deterioration treating unit 36 may perform control based on a pre-decided upper limit and lower limit of the SOC range as the provisional SOC estimated value.

In this way, in accordance with the satisfaction of the second sudden change determination condition, the estimated accuracy deterioration treating unit 36 performs the process of using the SOC estimated value using the provisional SOC estimated value. Then, although the accuracy of the alternative SOC estimated value is low, the normal range can be maintained for a result of the process of using the SOC estimated value.

In accordance with the satisfaction of the first sudden change determination condition, the estimated accuracy deterioration information output unit 37 transmits an information frame including estimation accuracy deterioration information to the management server 100. At this time, the estimated accuracy deterioration information output unit 37 outputs the information frame including the estimation accuracy deterioration information to the communication unit 50. The communication unit 50 transmits the input information frame including the estimation accuracy deterioration information to the management server 100 via the network 200.

The estimated accuracy deterioration information output unit 37 may allocate a predetermined priority (which may be a preference) to the information frame including the estimation accuracy deterioration information transmitted by the communication unit 50. The estimated accuracy deterioration information output unit 37 may allocate, for example, a highest priority to the information frame including the estimation accuracy deterioration information. By setting a high priority in this way, an addition learning process performed by an additional learning unit 111 of the management server 100 can be preferentially performed in response to reception of the information frame including the estimation accuracy deterioration information in a process performed by the management server 100.

The vehicle control unit 38 performs traveling control of the vehicle 10 by controlling an operation of the electrically driven motor 52. The vehicle control unit 38 performs the battery state display on the basis of the SOC estimated value (the regular SOC estimated value, the alternative SOC estimated value, or the provisional SOC estimated value).

The management server 100 manages the subordinate vehicle 10. The management server 100 is configured as a computer system that includes a processor, a memory, and a communication device (none of which is illustrated).

The management server 100 manages the learned model serving as the regular model 31 for each vehicle 10 as the management of the vehicle 10. The management server 100 includes the machine learning unit 110 and the additional learning unit 111 as functional units corresponding to management of the learned model serving as the regular model 31. The functions of the machine learning unit 110 and the additional learning unit 111 are implemented by causing a processor equipped in the management server 100 to execute a program.

The machine learning unit 110 performs machine learning of a machine learning model (an identifier internally kept in a relation between input data and output data) to generate a learned model corresponding to the regular model 31. When the learned model is generated, the machine learning unit 110 uses a sample data set indicating a relation between the first state variable and the second state variable of the battery obtained by an evaluation experiment or the like of an evaluation battery as training data.

As the machine learning model corresponding to the machine learning unit 110, a model of a neural network, a support vector machine, or the like may be used. For example, the machine learning model may be configured using a recurrent neural network (RNN). In this case, an intermediate layer of the RNN may be configured by a long short-term memory (LSTM) or a gated recurrent unit (GRU).

The additional learning unit 111 performs additional learning of the learned model. The additional learning unit 111 performs control such that the regular model 31 equipped in the vehicle 10 is updated by reflecting an additional learning result of the learned model.

In the vehicle 10, there is a possibility of an event such as excess of a measured value (the first measured value (Mv(t1))) of a voltage, a current, or a temperature of the battery 54 at this time over a range of the training data used for the machine learning of the regular model 31 serving as the learned model when the first sudden change determination condition for transmitting the estimation accuracy deterioration information is satisfied in accordance with satisfaction of the first sudden change determination condition. The estimation accuracy of the regular model 31 in this case can be ascertained to deteriorate because the machine learning is not performed including the measured value of the first state variable corresponding to the satisfaction of the present first sudden change determination condition.

When such an event occurs, the estimation accuracy is required to be raised by performing additional learning with the measured value of the first state variable corresponding to the satisfaction of the present first sudden change determination condition on the learned model serving as the regular model 31 so far.

Accordingly, the additional learning unit 111 performs the additional learning as follows in accordance with reception of the estimation accuracy deterioration information transmitted from any vehicle 10.

The estimated accuracy deterioration treating unit 36 of the vehicle 10 includes the measured value of the first state variable input to the regular model 31 to correspond to the satisfaction of the first sudden change determination condition in the estimation accuracy deterioration information to be transmitted to the management server 100.

The additional learning unit 111 performs the additional learning of the learned model corresponding to the regular model 31 using the first measured value Mv(t1) included in the received estimation accuracy deterioration information.

As a specific example, the additional learning unit 111 may acquire the SOC corresponding to the first measured value Mv(t1) by extracting the SOC of the evaluation battery corresponding to the first measured value Mv(t1) from evaluation experiment data. Alternatively, the additional learning unit 111 may acquire the SOC corresponding to the first measured value Mv(t1) by calculating a simulation value of the SOC of the evaluation battery with respect to the first measured value Mv(t1) through computer simulation. The additional learning unit 111 performs the additional learning of the learned model using the first measured value Mv(t1) and the training data corresponding to the foregoing acquired SOC.

When it is checked that the first measured value Mv(t1) obtained by the first state variable measurement unit 32 is measured with high accuracy, the additional learning unit 111 may perform the additional learning using the estimation accuracy deterioration information itself including the first measured value Mv(t1).

The additional learning unit 111 transmits updated data of the learned model obtained by performing the additional learning to each of the subordinate vehicles 10. The vehicle processor 30 in the vehicle 10 updates the regular model 31 serving as the learned model with the received updated data. The regular model 31 may be updated by, for example, the estimated accuracy deterioration treating unit 36.

In the state estimation system in FIG. 1, the estimated accuracy deterioration information output unit 37 and the additional learning unit 111 may be omitted in the first embodiment to correspond to a second embodiment.

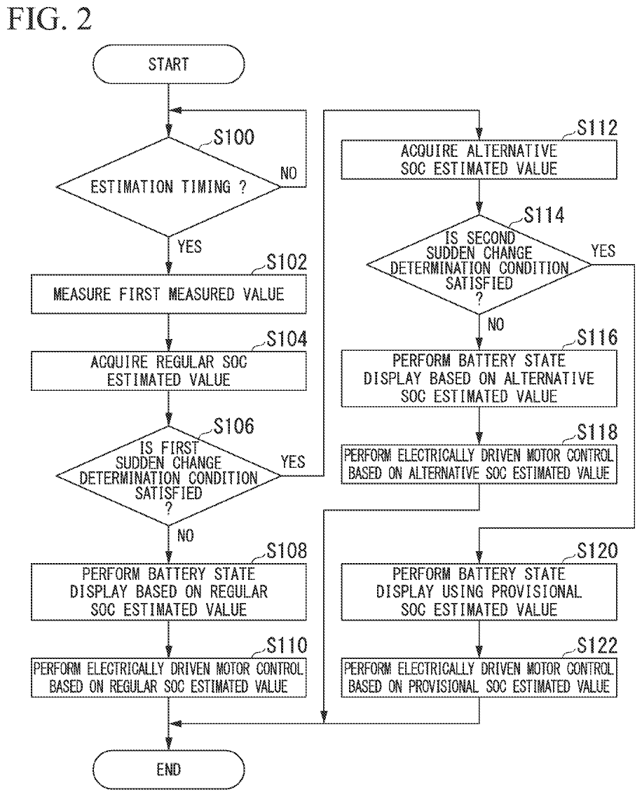

An exemplary order of a process performed with regard to an output of the SOC estimated value by the vehicle controller 20 according to the embodiment will be described with reference to the flowchart of FIG. 2.

The first state variable measurement unit 32 in the vehicle controller 20 waits for a coming estimation timing of the SOC estimated value (NO in step S100). The estimation timing of the SOC estimated value may be, for example, a timing coming at each predetermined time interval.

When the estimation timing of the SOC estimated value comes (YES in step S100), the first state variable measurement unit 32 measures the first measured value Mv(t1) from a detection output of the battery sensor 53 (step S102). The first measured value Mv(t1) is a measured value of a voltage, a current, or a temperature of the battery 54.

The second state variable estimation unit 33 inputs the first measured value Mv(t1) measured in step S102 into the regular model 31 and acquires the regular SOC estimated value output from the regular model 31 (step S104).

Subsequently, the second state variable estimation unit 33 determines whether the first sudden change determination condition is satisfied by the regular SOC estimated value acquired in step S104 (step S106).

In step S106, the second state variable estimation unit 33 sets the regular SOC estimated value acquired in step S104 of the present time as a first regular SOC estimated value Sv1(t1) and sets a regular SOC estimated value acquired in in step S104 of one previous (immediately previous) time as a second regular SOC estimated value Sv2(t2).

At this time, when the first sudden change determination condition is not satisfied by the regular SOC estimated value acquired in step S104 of the present (t1) time, the second state variable estimation unit 33 sets a regular SOC estimated value acquired in step S104 of the present (t1) time as the second regular SOC estimated value Sv2(t1). Conversely, when the first sudden change determination condition is satisfied by the regular SOC estimated value acquired in step S104 of the present (t1) time, the second state variable estimation unit 33 sets a regular SOC estimated value determined finally not to satisfy the first sudden change determination condition at one previous (immediately previous) time of the present time as the second regular SOC estimated value Sv2(t2).

The second state variable estimation unit 33 determines whether the first sudden change determination condition is satisfied depending on whether the first regular SOC estimated value Sv1(t1) is changed by a given value or more with respect to the second regular SOC estimated value Sv2(t2).

In the foregoing step S106, the second regular SOC estimated value Sv2(t2) used to determine whether the first sudden change determination condition is satisfied is a regular SOC estimated value output by the regular model 31 in step S104 of one previous (immediately previous) time. However, the second regular SOC estimated value Sv2 used in the determination of step S106 may be not output by the regular model 31.

For example, the second regular SOC estimated value Sv2 used in the determination of step S106 may be an SOC calculated on the basis of an integrated value of a current (a discharge current) measured by the first state variable measurement unit 32 using the previous reliable first regular SOC estimated value Sv1 as a reference. For example, “the previous reliable first regular SOC estimated value Sv1” may be an SOC when the battery 54 is fully charged. In this case, the second state variable estimation unit 33 may obtain the second regular SOC estimated value Sv2(t1) at the same time as the first regular SOC estimated value Sv1(t1). Further, the second state variable estimation unit 33 may determine that the first sudden change determination condition is satisfied when a difference between the first regular SOC estimated value Sv1(t1) and the second regular SOC estimated value Sv2(t1) of the same time is equal to or greater than a predetermined value or a matching ratio is equal to or less than a given ratio.

The second regular SOC estimated value Sv2 used in the determination of step S106 may be an SOC calculated on the basis of the integrated value of the current measured by the first state variable measurement unit 32 using an SOC calculated value based on a closed circuit voltage (CCV)/open circuit voltage (OCV) of the battery 54 as a reference. In this case, the second state variable estimation unit 33 may obtain the second regular SOC estimated value Sv2(t1) of the same time as the first regular SOC estimated value Sv1(t1). The second state variable estimation unit 33 may determine that the first sudden change determination condition is satisfied when the difference between the obtained first regular SOC estimated value Sv1(t1) and second regular SOC estimated value Sv2(t1) of the same time is equal to or greater than the predetermined value or the matching ratio is equal to or less than the given ratio.

When it is determined that the first sudden change determination condition is not satisfied (NO in step S106), the second state variable estimation unit 33 performs control such that the battery state display based on the regular SOC estimated value acquired in the final step S104 is performed (step S108). In this case, the vehicle control unit 38 performs the battery state display so that information such as a charging rate or a travelable distance calculated on the basis of the regular SOC estimated value is presented.

The second state variable estimation unit 33 performs the electrically driven motor control based on the regular SOC estimated value acquired in the final step S104 (step S110). In this case, the vehicle control unit 38 controls the electrically driven motor 52 such that the battery 54 is charged or discharged at a charge amount or a discharge amount set on the basis of the result SOC estimated value.

When it is determined that the first sudden change determination condition is satisfied (YES in step S106), the alternative estimation unit 34 acquires the alternative SOC estimated value. In this case, the alternative estimation unit 34 acquires the alternative SOC estimated value calculated by the alternative model 35 (step S112).

After the process of step S112, the estimated accuracy deterioration treating unit 36 determines whether the second sudden change determination condition is satisfied by the alternative SOC estimated value calculated by the alternative estimation unit 34 (step S114).

When it is determined that the second sudden change determination condition is not satisfied (NO in step S114), the estimated accuracy deterioration treating unit 36 performs control such that the battery state display based on the alternative SOC estimated value acquired in step S112 is performed (step S116).

The estimated accuracy deterioration treating unit 36 performs control such that the electrically driven motor control based on the alternative SOC estimated value acquired in step S112 is performed (step S118).

When it is determined that the second sudden change determination condition is satisfied (YES in step S114), the estimated accuracy deterioration treating unit 36 performs control such that the battery state display based on the provisional SOC estimated value determined to correspond to the battery state display is performed (step S120).

The provisional SOC estimated value corresponding to step S120 may be the second regular SOC estimated value Sv2(t2). For the process of step S120, for example, the second state variable estimation unit 33 stores the acquired regular SOC estimated value in the memory 40 in response to the acquisition of the regular SOC estimated value.

The estimated accuracy deterioration treating unit 36 performs control such that the electrically driven motor control based on the provisional SOC estimated value is performed (step S122). The provisional SOC estimated value corresponding to step S122 may be a pre-decided upper limit or lower limit of the SOC range.

### Second Embodiment

Next, a second embodiment will be described. There is a possibility of the first measured value Mv(t1) being measured outside of a range of training data when the learned model serving as the regular model 31 so far is constructed in accordance with satisfaction of the first sudden change determination condition. In this case, reliability of the regular SOC estimated value output by the regular model 31 deteriorates. That is, deterioration in accuracy of the regular SOC estimated value output by the regular model 31 occurs.

Accordingly, in the embodiment, in accordance with satisfaction of the first sudden change determination condition, additional learning is performed on the learned model serving as the regular model 31 mounted on the vehicle controller 20 of the vehicle 10 and the regular model 31 is updated with the learned model after the additional learning. Thus, it is possible to maintain the accuracy of the regular SOC estimated value output by the regular model 31.

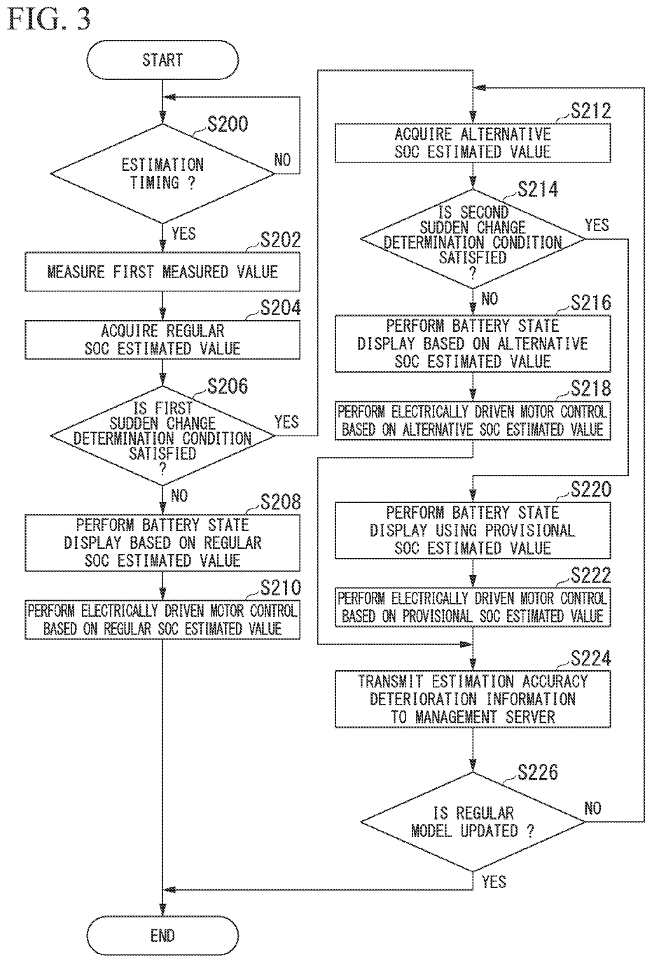

An exemplary order of a process performed with regard to an output of the SOC estimated value by the vehicle controller 20 according to the embodiment will be described with reference to the flowchart of FIG. 3.

Processes of steps S200 to S222 are similar to those of steps S100 to S122 of FIG. 2.

After the process of step S218 or S222, the estimated accuracy deterioration information output unit 37 transmits the estimation accuracy deterioration information to the management server 100 (step S224). The estimation accuracy deterioration information includes the first measured value Mv(t1) measured in the final step S202.

In accordance with the transmission of the estimation accuracy deterioration information in step S224, the management server 100 performs the additional learning on the learned model applied to the regular model 31 and transmits updated data corresponding to the learned model in which a result of the additional learning is reflected to each vehicle 10. The vehicle processor 30 of the vehicle 10 receiving the updated data updates the regular model 31 with the received updated data.

Accordingly, after the estimation accuracy deterioration information is transmitted in step S224 is transmitted, the estimated accuracy deterioration treating unit 36 determines whether the regular model 31 is updated (step S226). When it is determined in step S226 that the regular model 31 is not updated, the process of step S212 is returned.

The regular model 31 is updated in accordance with the estimation accuracy deterioration information transmitted to the management server 100 by another vehicle 10 in some cases. However, when the regular model 31 is updated in this way, the estimated accuracy deterioration treating unit 36 may determine in step S226 that the regular model 31 is updated.

When the regular model 31 is updated, the process in the drawing ends. The processes subsequent to step S202 are performed after waiting until a subsequent estimation timing in S200.

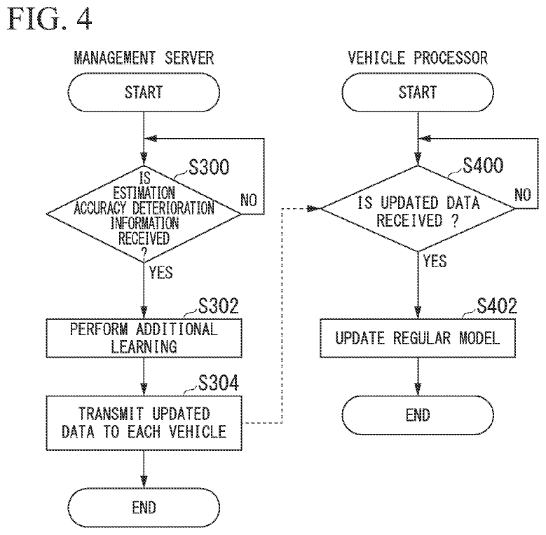

An exemplary order of a process performed with regard to updating of the learned model serving as the regular model by the management server 100 and the vehicle controller 20 according to the embodiment will be described with reference to the flowchart of FIG. 4.

The additional learning unit 111 in the management server 100 waits for receiving the estimation accuracy deterioration information (NO in step S300).

When the estimation accuracy deterioration information is received (YES in step S300), the additional learning unit 111 performs the additional learning of the learned model serving as the regular model 31 using the first measured value included in the received estimation accuracy deterioration information (step S302).

The additional learning unit 111 transmits the updated data corresponding to the learned model updated in step S302 to each vehicle 10 (step S304).

The estimated accuracy deterioration treating unit 36 of the vehicle processor 30 in the vehicle 10 waits for receiving the updated data transmitted from the management server 100 (NO in step S400).

When the updated data is received (YES in step S400), the estimated accuracy deterioration treating unit 36 updates the regular model 31 with the received updated data (step S402).

According to the exemplary orders of the processes of FIGS. 3 and 4, in accordance with satisfaction of the first sudden change determination condition in step S206, the process of using the SOC estimated value based on the alternative SOC estimated value (steps S216 and S218) or the process of using the SOC estimated value based on the provisional SOC estimated value (steps S220 and S222) continues until the learned model serving as the regular mode 31 is updated. That is, until the deterioration of the accuracy the regular SOC estimated value output by the learned model serving as the regular model 31 is solved, the process of using the SOC estimated value based on the alternative SOC estimated value or the provisional SOC estimated value is performed without being based on the regular SOC estimated value. That is, until the learned model serving as the regular model 31 is updated and the deterioration in the accuracy is solved, the process of using the SOC estimated value can be performed within a proper range by performing the process of using the SOC estimated value based on the alternative SOC estimated value or the provisional SOC estimated value. When the learned model serving as the regular model 31 is updated, the process of using the SOC estimated value based on the regular SOC estimated value can be performed subsequently.

When the learned model serving as the regular model 31 is updated in order as in the second embodiment, a learned model before the updating to the learned model serving as the present regular model 31 may be applied as the alternative model 35.

When the first sudden change determination condition is satisfied, there is a high possibility of the accuracy of the learned model before the updating being higher than the learned model serving as the regular model 31 outputting the regular SOC estimated value when the first sudden change determination condition is satisfied. Accordingly, by using the learned model before the updating as the alternative model 35, it is possible to achieve compensation of the accuracy of the SOC estimated value.

In each of the foregoing embodiments, a monitoring target may be a battery other than the battery 54 equipped in the vehicle 10. The monitoring target in the embodiment may be a target other than a battery.

The management server 100 may have the function of determining whether the first sudden change determination condition is satisfied in the second state variable estimation unit 33 and the function of determining whether the second sudden change determination condition is satisfied in the estimated accuracy deterioration treating unit 36. Further, the management server 100 may have a function of acquiring the alternative SOC as the alternative estimation unit 34 or a function of calculating an alternative SOC estimated value as the alternative model 35. In this case, the calculated alternative SOC estimated value may be transmitted to a monitoring target by the management server 100.

The process in the above-described vehicle controller 20, management server 100, or the like may be performed by recording a program for implementing the functions of the above-described vehicle controller 20, management server 100, or the like on a computer-readable recording medium, reading the program recorded on the recording medium to a computer system, and executing the program. Here, “the reading the program recorded on the recording medium to the computer system and the executing of the program” includes installing of the program on the computer system. The “computer system” mentioned here is assumed to include an OS or hardware such as a peripheral device. The “computer system” may include a plurality of computer devices connected via a network including communication lines such as the Internet, a WAN, a LAN, and a dedicated line. The “computer-readable recording medium” is a portable medium such as a flexible disk, a magneto-optical disc, a ROM, or a CD-ROM or a storage device such as a hard disk contained in a computer system. In this way, a recording medium storing the program may be a non-transitory recording medium such as a CD-ROM. The recording medium also includes am internally or externally provided recording medium which can be accessed by a delivery server to deliver the program. A code of the program stored in the recording medium of the delivery server may be different form a code of a program with a format which can be executed with a terminal device. That is, any format of the program stored in the delivery server does not matter as long as the format can be installed in a form of the program which can be downloaded from the deliver server and can be executed by a terminal device. The program may be divided into a plurality of programs and the divided programs may be downloaded at different timings to be combined in a terminal device or delivery servers to which the divided programs are delivered may be different. Further, the “computer-readable recording medium” is assumed to include a medium that retains the program for a given time, such as a volatile memory (RAM) inside a computer system serving as a server or a client when the program is transmitted via a network. The program may be a program for implementing some of the above-described functions. Further, the program may be a program for implementing the above-described functions in combination with a program already recorded on the computer system or may be a so-called differential file (a differential program).

The embodiments for carrying out the present invention have been described above, but the present invention is not limited to the embodiments. Various modifications and substitutions can be made within the scope of the present invention without departing from the gist of the present invention.

What is claimed is:

1. A state estimation system comprising one or more processors functioning as:
a learned model generated so that a measured value of a first state variable is input and an estimated value of a second state variable is output through machine learning in which sample data of the first and second state variables of a predetermined target is training data;
a first state variable measurement unit configured to measure the first state variable of a monitoring target which is the target serving as a monitoring target;
a second state variable estimation unit configured to repeatedly perform, at a predetermined estimation timing, a second state variable estimation process of inputting the measured value of the first state variable measured by the first state variable measurement unit into the learned model and acquiring an output of the learned model as the estimated value of the second state variable of the monitoring target; and
an alternative estimation unit configured to output an alternative estimated value which is an alternative value of the estimated value of the second state variable in a case in which a predetermined first sudden change determination condition is satisfied by the estimated value of the second state variable acquired in response to an input of a first measured value of the first state variable through the second state variable estimation process.

2. The state estimation system according to claim 1, wherein the alternative estimation unit outputs the alternative estimated value in accordance with another method which is a substitute for the learned model used in the second state variable estimation process to correspond to the case in which a first sudden change determination condition is satisfied.

3. The state estimation system according to claim 2,
wherein the learned model in the second state variable estimation unit is updated, and
wherein the alternative estimation unit outputs the alternative estimated value using a learned model before the updating to the used learned model.

4. The state estimation system according to claim 1, wherein the first sudden change determination condition is a condition that a first estimated value of the second state variable acquired through the second state variable estimation process from the input of the first measured value of the first state variable is changed by a given value or more with respect to a second estimated value of the second state variable acquired through the second state variable estimation process from an input of a second measured value of the first state variable measured by the first state variable measurement unit at an estimation timing earlier than an estimation timing at which the first measured value is input.

5. The state estimation system according to claim 1,
wherein the monitoring target is mounted in a moving object, and
wherein the state estimation system further comprises an estimation accuracy deterioration treating unit configured to perform a predetermined process performed on the basis of the estimated value in the moving object on the basis of the alternative estimated value instead of the estimated value in accordance with calculation of the alternative estimated value by the alternative estimation unit.

6. The state estimation system according to claim 5, wherein the predetermined process is display of a state of the monitoring target on a display unit equipped in the moving object.

7. The state estimation system according to claim 5, wherein the predetermined process is control of an electrically driven motor equipped in the moving object.

8. The state estimation system according to claim 5, wherein the estimation accuracy deterioration treating unit prohibits the predetermined process based on the alternative estimated value from being performed in a case in which a predetermined second sudden change determination condition is satisfied by the alternative estimated value when the alternative estimated value is calculated by the alternative estimation unit.

9. The state estimation system according to claim 8,
wherein the predetermined process is display of a state of the monitoring target on a display unit equipped in the moving object, and
wherein the estimation accuracy deterioration treating unit causes the display unit to display the state of the monitoring object on the basis of a second estimated value of the second state variable acquired through the second state variable estimation process at an estimation timing earlier than an estimation timing at which the first measured value is input when the state of the monitoring target is prohibited from being displayed on the display unit based on the alternative estimated value.

10. The state estimation system according to claim 8,
wherein the predetermined process is control of an electrically driven motor equipped in the moving object, and
wherein the estimation accuracy deterioration treating unit controls the electrically driven motor on the basis of a preset upper limit or lower limit of a predetermined range of the second state variable when the electrically driven motor is prohibited from being controlled.

11. The state estimation system according to claim 1,
wherein the monitoring target is a battery,
wherein the first state variable includes at least one of a voltage, a current, and a temperature of the battery, and
wherein the second state variable is a state of charge (SOC) of the battery.

12. A computer-readable non-transitory storage medium that stores a program causing a computer to function as:
a learned model generated so that a measured value of a first state variable is input and an estimated value of a second state variable is output through machine learning in which sample data of the first and second state variables of a predetermined target is training data;
a first state variable measurement unit configured to measure the first state variable of a monitoring target which is the target serving as a monitoring target;
a second state variable estimation unit configured to repeatedly perform, at a predetermined estimation timing, a second state variable estimation process of inputting the measured value of the first state variable measured by the first state variable measurement unit into the learned model and acquiring an output of the learned model as the estimated value of the second state variable of the monitoring target; and
an alternative estimation unit configured to output an alternative estimated value which is an alternative value of the estimated value of the second state variable in a case in which a predetermined first sudden change determination condition is satisfied by the estimated value of the second state variable acquired in response to an input of a first measured value of the first state variable through the second state variable estimation process.
